(19) United States
(12) Patent Application Publication
(10) Pub. No.: US 2005/0167858 A1
(43) Pub. Date: Aug. 4, 2005

(54) Aerator apparatus and method of use

(76) Inventors: Robert L. Jones, Glen Allen, MS (US); Roland Schmidt, Macon, MS (US)

Correspondence Address: BUTLER, SNOW, O'MARA, STEVENS & CANNADA PLLC, 6075 POPLAR AVENUE, SUITE 500, MEMPHIS, TN, 38119, US

(21) Appl. No.: 10/772,126

(22) Filed: Feb. 4, 2004

(51) Int. Cl. B01F 3/04

(52) U.S. Cl. 261/28; 261/37; 261/122.1; 261/123

(57) ABSTRACT

This invention relates to an aerator apparatus having a plurality of porous tubes coupled to a blower. The blower forces air through the porous tubing into a mixing chamber. A propeller propels water into the mixing chamber. Air and water are mixed in the mixing chamber. The result being a highly oxygenated liquid, such as water. This invention also relates to a method to use the aerator apparatus attached to a floatable frame to diffuse a gas into a liquid. This invention also relates to a system for efficiently aerating a pond or column of water wherein a bubble generator is enclosed in a removable housing.

### RELATED APPLICATIONS

Not Applicable

### STATEMENT REGARDING FEDERALLY SPONSORED RESEARCH OR DEVELOPMENT

Not Applicable

### REFERENCE TO A “MICROFICHE APPENDIX”

Not Applicable

### FIELD OF THE INVENTION

This invention relates to an aerator apparatus having a bubble generator in a mixing chamber. The bubble generator functions to diffuse a gas into a stream of liquid flowing through the mixing chamber. Additionally, this invention relates to a method to use the aerator apparatus mounted on a floatable frame to diffuse a gas into a pond or column of water.

### BACKGROUND OF THE INVENTION

In the present aeration technology, paddlewheel type rotors are driven by electric motors coupled to a mechanical gear reducer that is either connected directly to the rotor by couplings or indirectly by belts. The paddlewheel type aerator generators supply oxygen by splashing the surface of the water to entrain air into a current induced by the paddlewheel. These types of apparatuses require a substantial amount of maintenance and have high energy requirements. In other aerators, such as the one shown in U.S. Pat. No. 4,954,295, propellers are employed but without a separate bubble generator means. The propeller itself is used to aerate the liquid. These types of aerators do not provide sufficient gas delivery. A simpler more energy efficient aerator apparatus that can deliver a highly aerated liquid is needed.

### SUMMARY OF THE INVENTION

In the present invention, a gas, such as air, is forced into a mixing chamber wherein the gas is diffused into a liquid, such as water. The mixing chamber contains a bubble generator which includes a plurality of porous tubes for diffusing a gas into a liquid flowing through the mixing chamber. The gas saturated liquid is then forced out of the mixing chamber by a propeller.

More specifically, the present invention includes an aerator apparatus for mixing a gas with a liquid. The aerator apparatus is made of a first motor having a shaft with a blower operatively connected to the first motor. It also has a mixing chamber made of an enclosing wall having a proximal opening and a distal opening. A bubble generator is located within the mixing chamber and it is operatively connected to the blower. The gas blown into the bubble generator diffuses into the liquid flowing through the mixing chamber. A propeller is positioned to propel water into the proximal opening of the mixing chamber and out of the distal opening of the mixing chamber.

The present invention also includes a method of diffusing a gas into a liquid to be treated. The first step is to mount the aeration apparatus of this invention on a floatable frame to form an aeration assembly. The second step is to dispose the aeration assembly in to the liquid to be treated. The next step involves blowing a gas into the bubble generator of the aerator apparatus and rotating the propeller to induce a flow of the liquid by the propeller through the mixing chamber. The last step involves diffusing a gas into the liquid and propelling the liquid from the aerator apparatus into the pond or column of water.

### BRIEF DESCRIPTION OF THE DRAWINGS

FIG. 1 is a perspective view of the present invention.

FIG. 2A is a perspective view of a portion of an embodiment of the present invention.

FIG. 2B is a perspective view of a portion of another embodiment of the invention.

FIG. 3 is a plan view of a portion of the invention.

FIG. 4A is an elevational view of the housing 40.

FIG. 4B is a cross-sectional view of FIG. 4A taken at 4B-4B.

FIG. 5 is a perspective view of another embodiment of the invention.

FIG. 6 is a cross-sectional view of FIG. 5 taken at 6-6 through both enclosing walls of the mixing chamber 30.

FIG. 7A is an elevational perspective view of the floatable frame 60.

FIG. 7B is a side view of a lower portion of the floatable frame 60.

### DETAILED DESCRIPTION OF THE PREFERRED EMBODIMENMT

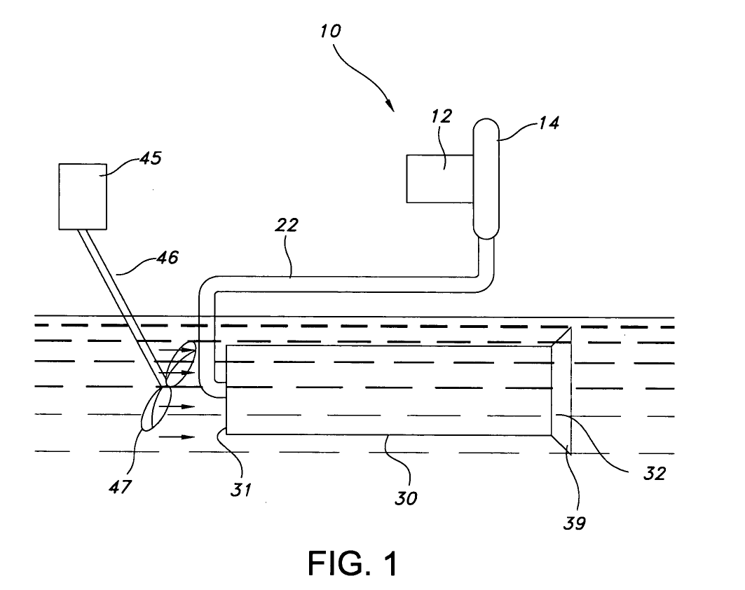

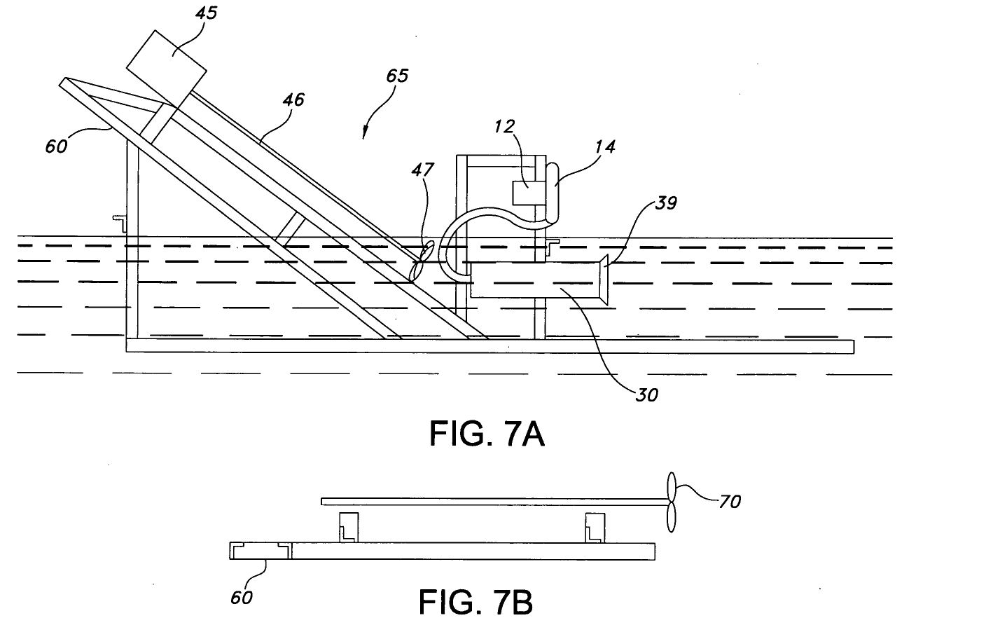

Referring to FIG. 1, an aerator apparatus 10 is shown. The function of the aerator apparatus 10 is to efficiently mix a gas with a liquid. The aerator apparatus 10 of the present invention achieves that objective with a minimum of mechanical gears and couplings. The aerator apparatus 10 in its most basic form is a mixing chamber 30 which is located substantially perpendicularly to the surface of the water. The mixing chamber 30 is a generally tubular structure having a proximal opening 31 and a distal opening 32. A propeller 47 propels a liquid, such as, water into the proximal opening 31 of the mixing chamber 30. In the mixing chamber 30, water is mixed with a gas, such as oxygen. The aerated water is then propelled out of the distal opening 32 of the mixing chamber 30 into a pond or column of water. FIG. 1 shows the aerator apparatus 10 in a liquid without a floatable frame 60 to show the relationship of various elements of the device. In actual operation, the aerator apparatus 10, however, would be mounted in a floatable frame 60 as shown in FIG. 7A.

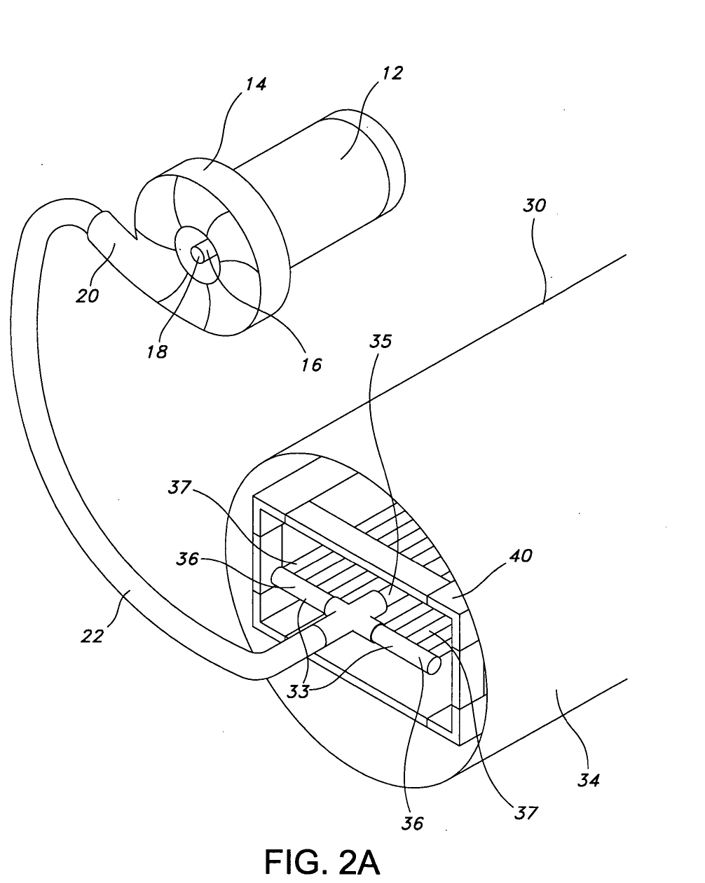

More specifically, as shown in FIG. 2A, the mixing chamber 30 is formed by an enclosing wall 34. The enclosing wall 34 in the preferred embodiment is PVC, but can be made of stainless steel (galvanized or nongalvanized), metal or any other suitable material. A gas is blown into a bubble generator 33 to facilitate the delivery of the gas into the liquid flowing through the mixing chamber 30. In the preferred embodiment, the mixing chamber 30 is 12 inches in diameter, but can be made of any suitable diameter, i.e. of sufficient size to accommodate the bubble generator 33 and to facilitate mixing of the gas and liquid. For example, if the gas is oxygen, oxygenated water is propelled from the mixing chamber 30 into a pond or a column of water. The following detailed description of the invention describes the preferred embodiment and various alternative embodiments that function in the same way to achieve this result.

Referring to FIGS. 1 and 2A, the aerator apparatus 10 includes a first motor 12 and blower 14. The first motor 12 is operatively connected to blower 14 by shaft 16. The first motor 12 is sized to operate blower 14. The blower 14 includes a gas inlet 18 for preferably intaking air. The blower 14 also includes a gas outlet 20, preferably for discharging air into the aerator apparatus 10. The function of the blower 14 is to blow air into the bubble generator 33. The blower 14, in the preferred embodiment is a Regenair® (Benton Harbor, MI) M & H Series High Pressure/Vacuum Oiless Regenerative Blower. The blower 14 functions at low pressure and produces a high output of air into the aerator apparatus 10.

The blower 14 is operatively connected to a bubble generator 33. The term operatively connected means connected or attached in a way to allow the connected device to operate or function as intended. In the preferred embodiment, the blower 14 is operatively connected to the bubble generator 33 (through manifold 36) at the proximal opening 31 of the mixing chamber 30; however, the blower 14 can be operatively connected anywhere along the length of the mixing chamber 30 and by multiple connection hoses (not shown), such as when multiple manifolds are used.

The function of the bubble generator 33 is to form bubbles for delivery to the liquid in the mixing chamber 30. The bubbles increase the amount of surface area of gas in contact with the liquid. This bubble generator 33 includes main pipe 35 connected to at least one manifold 36 by tube 22. The main pipe 35 runs the length of the bubble generator 33. The main pipe 35 is connected to at least one manifold 36. The at least one manifold 36 is also connected to a plurality of porous tubes 37. The main pipe 35 and the plurality of porous tubes 37 in the preferred embodiment are formed of 1½ inch O.D. porous tube. The plurality of porous tubes 37 and main pipe 35 are preferably made of a synthetic rubber (open cell) (ASI, Lexington, Tennessee), such as Neoprene, but can be made of any material porous to the gas to be diffused. In an alternative embodiment, the main pipe 35 is made of nonporous material such as polyethylenes, but is operably connected to a plurality of porous tubes 37. The main pipe 35 can be sized larger than the plurality of porous tubes 37 to facilitate the delivery of the gas to the mixing chamber 30.

The function of the plurality of porous tubes 37 and the main pipe 35 is to diffuse a gas, such as oxygen or nitrogen, into a liquid, such as water, however, in an alternative embodiment, such as wastewater clean-up a chemical is diffused into the water.

The bubble generator 33 is made of a main pipe 35, at least one manifold 36 and a plurality of porous tubes 37. The porous tubes 37 and main pipe 35 are positioned longitudinally in the bubble generator 33. The gas enters at the proximal opening 31 of the mixing chamber 30 and a portion of the gas flows through the plurality of porous tubes 37 and another portion flows through main pipe 35 to at least one manifold 36. The at least one manifold 36 is attached perpendicularly with respect to the main pipe 35 and the plurality of porous tubes 37.

The function of the propeller 47 is to propel a liquid into the mixing chamber 30. The propeller 47 is positioned substantially adjacent at the proximal opening 31 of the mixing chamber 30. A second motor 45 has a shaft 46 connected to propeller 47. The second motor 45 is sized to operate propeller 47. The propeller 47 produces a current of liquid that is propelled through mixing chamber 30 to deliver oxygenated water to the pond or column of water. The water is propelled into mixing chamber 30 at a variable rate depending on the configuration of the apparatus. A diffuser 39 is positioned at the distal opening 32 of the mixing chamber 30. The function of the diffuser 39 is to disperse the gas into the liquid. In the preferred embodiment, the diffuser 39 is a deflector which deflects the liquid downwardly.

In the embodiment shown in 2B, the bubble generator 33 is attached directly to mixing chamber 30. More specifically in this embodiment, the least one manifold 36 can be bolted (not shown) to the enclosing wall 34 to fix the bubble generator 33 to the mixing chamber 30.

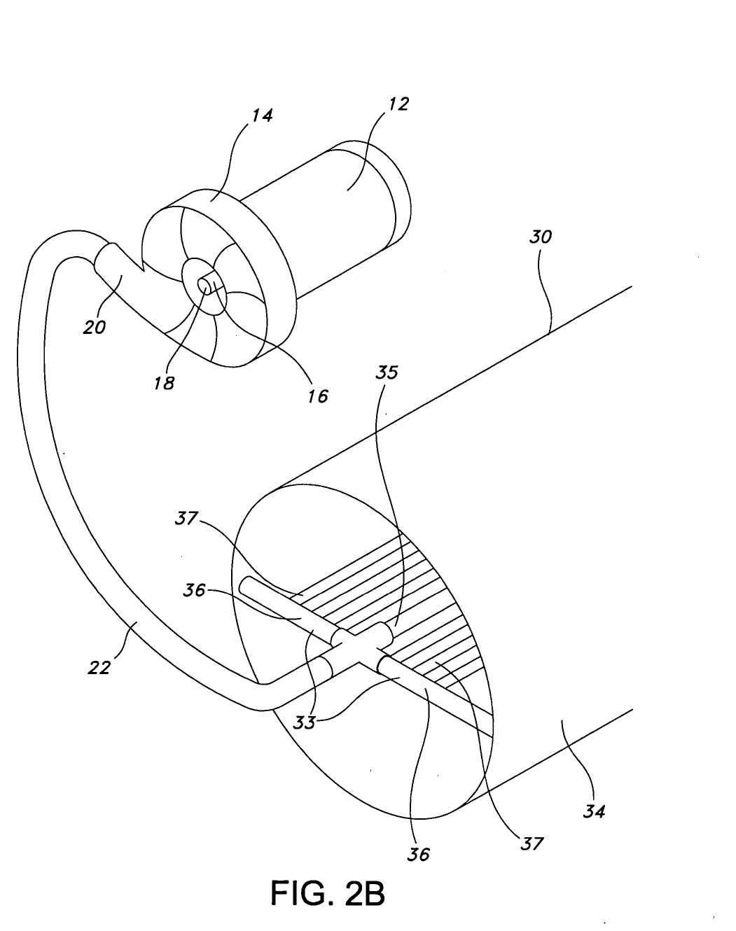

The function of the manifold 36 is to spread the flow of gas over a number of porous tubes 37 which are located parallel to main pipe 35. In the preferred embodiment shown in FIG. 3, the gas enters the bubble generator 33 at the at least one manifold 36, which in this embodiment is referred to as the proximal manifold (by way of tube 22) and is distributed in part to main pipe 35 and in part to a first section 48 of the plurality of porous tubes. An intermediate manifold 42 distributes the gas to the first section 48 of the porous tubes and a second section 49 of porous tubes. A third manifold 43 distributes the gas to the second section 49 of porous tubes. In an alternative embodiment, the intermediate manifold 42 could be a support member (not shown) that functions to support the porous tubes sections 48 and 49, but does not function to recirculate the gas. In the embodiment shown in FIG. 3, the distal manifold 43 and intermediate manifold 42 further spreads the flow of gas to physically distant porous tubes 37. The arrangement can be repeated adding additional sections of porous tubes 37.

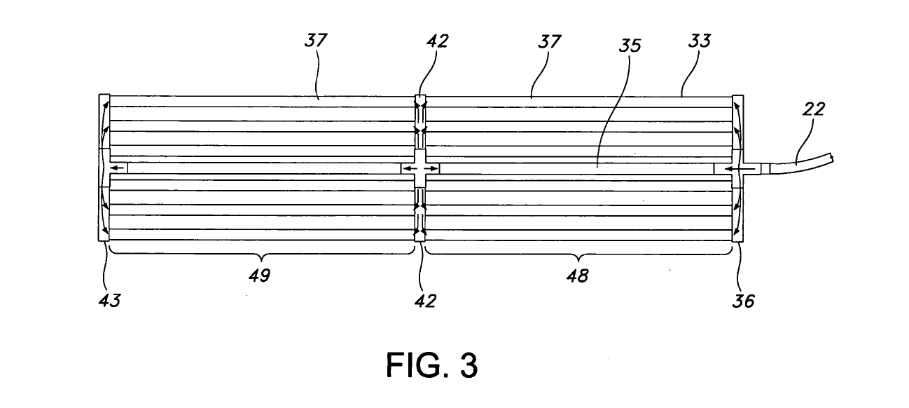

Now referring to FIGS. 4A and 4B, a removable housing 40 is sized to fit inside of the mixing chamber 30. The function of the removable housing 40 is to provide an easily replaceable section to house the bubble generator 33. In this way, if porous tubes 37 are damaged or become clogged, the removable housing 40 can be replaced without damage to the mixing chamber 30. The enclosure of the bubble generator 33 within the removable housing 40 provides a system for efficiently aerating a pond.

The removable housing 40 can include a plurality of mixing means to facilitate the mixing of the gas into the liquid. In the preferred embodiment, the mixing means are a plurality of mixing vanes 51 as shown in FIGS. 4A and 4B. The mixing vanes 51 can be positioned anywhere along the length of the removable housing 40.

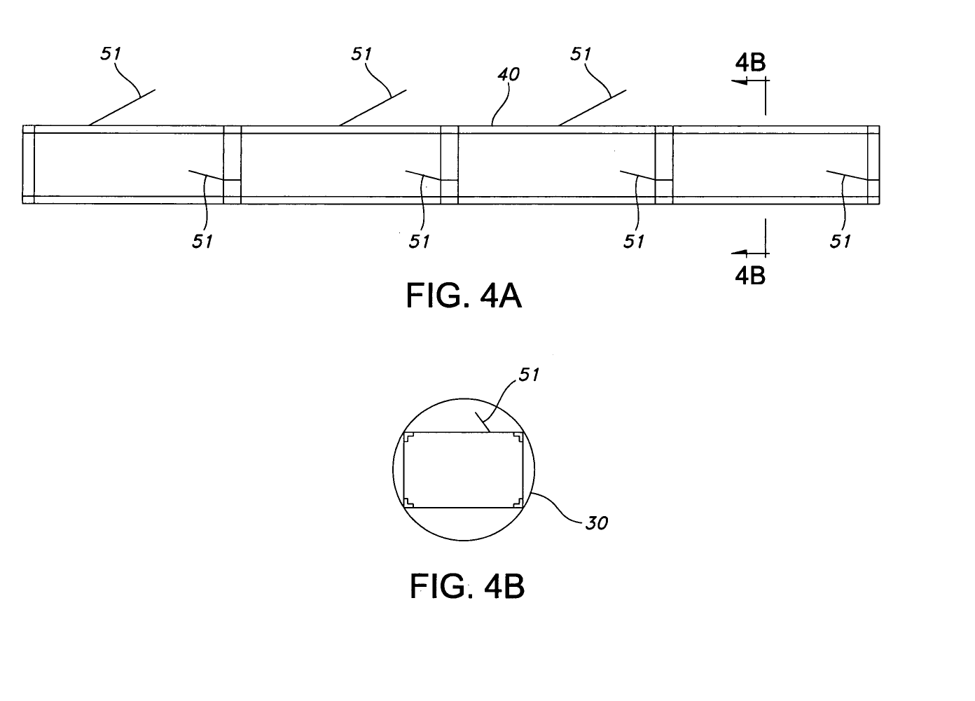

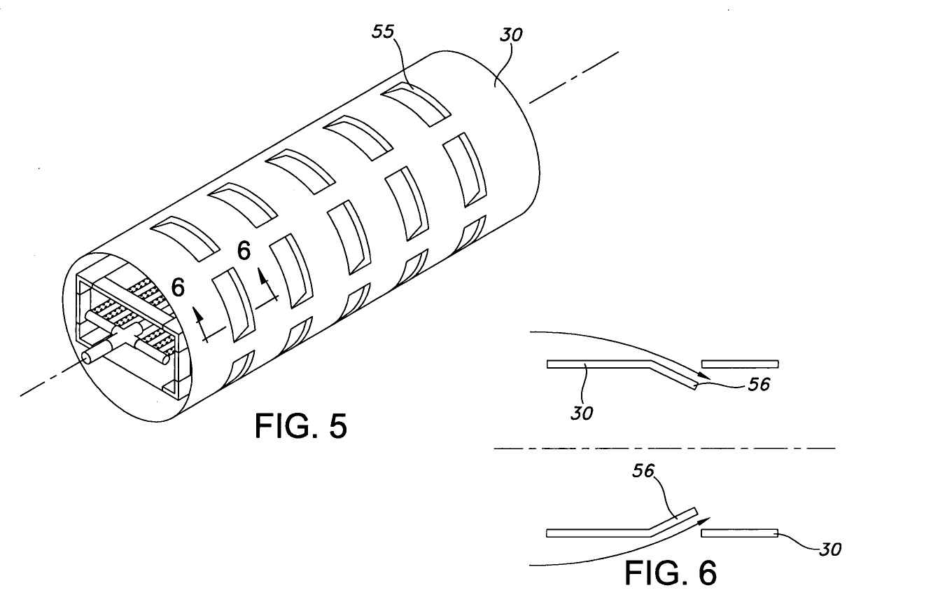

Referring now to FIGS. 5 and 6, an alternative embodiment of the mixing means is shown. In this embodiment the mixing chamber 30 includes a plurality of openings 55 along the length of mixing chamber 30 in the enclosing wall. The openings 55 can be rectangularly shaped and in one embodiment include a louvered member 56 that projects into the mixing chamber 30 to create additional mixing of the gas and liquid. FIG. 6 shows the flow of liquid in to the mixing chamber 33. The plurality of openings 55 facilitate the flow of additional liquids with reduced energy requirements. The plurality of openings 55 with the louvered member 56 can be formed by punching, plasma cutting, or any known sheet metal processing technique.

Now referring to FIGS. 7A and 7B, the aerator apparatus 10 is placed on a floatable frame 60. Floats can be attached anywhere along the length of the floatable frame 60 substantially perpendicular to the water. The floatable frame 60 positions the mixing chamber 30 and bubble generator 33 so that they are substantially parallel (no more than 15 degrees) to the surface of the liquid in which they are immersed. The frame 60 is further configured to position the propeller 47 adjacent to the proximal opening 31 of mixing chamber 30. In the preferred embodiment, the floatable frame 60 circulates water within the top sixty inches of a pond. The floatable frame 60 can include a propeller 70 to propel the floatable frame 60 and aeration apparatus 10 through the pond.

The combination of aerator apparatus 10 of the present invention and the floatable frame 60 is referred to as the aeration assembly 65. The aeration assembly 65 can be disposed into the liquid to be treated. More specifically, the aeration assembly can be disposed into a pond or a column of water. The blower 14 then blows air into the bubble generator 33 and the propeller 47 is rotated to induce the flow of liquid by the propeller 47 through the mixing chamber 30. The gas in the bubble generator 33 then diffuses into the liquid in the mixing chamber 30. The liquid containing the diffused gas is then propelled from the aerator assembly 65 into the pond or column of water.

TABLE 1

| Time (hr) | Temp* | DOs* | DOt* | DOs − DOt | In(DOs − DOt) |
|---|---|---|---|---|---|
| 0.75 | 15.4 | 10.15 | 0.68 | 9.47 | 2.248 |
| 1.00 | 15.4 | 10.15 | 1.23 | 8.92 | 2.188 |
| 1.25 | 15.5 | 10.13 | 1.58 | 8.55 | 2.146 |
| 1.50 | 15.5 | 10.13 | 2.05 | 8.08 | 2.089 |
| 1.75 | 15.6 | 10.11 | 2.58 | 7.53 | 2.019 |
| 2.00 | 15.6 | 10.11 | 3.03 | 6.81 | 1.918 |
| 2.25 | 15.7 | 10.09 | 3.43 | 6.66 | 1.896 |
| 2.50 | 15.7 | 10.09 | 3.78 | 6.31 | 1.842 |
| 2.75 | 15.8 | 10.07 | 4.18 | 5.89 | 1.773 |
| 3.00 | 15.8 | 10.07 | 4.53 | 5.54 | 1.712 |
| 3.25 | 15.9 | 10.05 | 4.78 | 5.27 | 1.662 |
| 3.50 | 15.9 | 10.05 | 5.03 | 5.02 | 1.613 |
| 3.75 | 15.9 | 10.05 | 5.35 | 4.72 | 1.552 |
| 4.00 | 15.9 | 10.05 | 5.53 | 4.52 | 1.508 |
| 4.25 | 15.9 | 10.05 | 5.78 | 4.27 | 1.452 |
| 4.50 | 15.9 | 10.05 | 6.03 | 4.02 | 1.391 |

*Temp = average of four stations in basin, approximately 0.5 m depth
*DOs = saturation DO concentration for specific temperature (from Colt, 1984), corrected to ambient station barometric pressure (773 mmHg) using the formula DOa = DOs(BP/760)
DOt = average of four stations in basin, approximately 0.5 m depth

Three linear regressions were performed to determine K_{L}a: 1) all 16 data pairs; 2) 13 data pairs from 20% saturation (time=1.50) till end of test; 3) 10 data pairs in the visually “linear” segment of the relationship (time=2.25 till the end of test).
Slope 1=0.230
Slope 2=0.226 (preferred value, shown in bold below)
Slope 3=0.221
   K_{L}a is the absolute value of the regression slope, and is used to calculate K_{L}a₂₀ which was based on average water temperature during the interval from which data pairs were selected:
Temperature 1=15.71
Temperature 2=15.77
Temperature 3=15.84
K_{L}a₂₀ 1=0.244 hr¹
K_{L}a₂2=0.250 hr¹
K_{L}a₂ 3=0.254 hr¹
   Standard Oxygen Transfer Rate (in pounds of oxygen/hour) as calculated using the standard formula:
   SOTR=(K_{L}a₂₀)(9.07)(V)(0.01)(2.205)
   V is the basin volume in cubic meters; 0.001 is the conversion from grams to kilograms; and 2.205 is the conversion from kilograms to pounds.
   Basin volume (V)=1.38 acre-feet=1,702.4 m³=determined by salt dilution
SOTR 1=8.31 lb O₂/hr
SOTR 2=8.51 lb O₂/hr
SOTR 3=8.65 lb O₂/hr
   Standard Oxygen Transfer Efficiency (pounds of oxygen/horsepower-hour) was calculated using the standard formula:
   SAE=SOTR/horsepower
   Power requirements for aerator=5.5 hp
SAE 1=1.51 lb O₂/hp-hr
SAE 2=1.55 lb O₂/hp-hr
SAE 3=1.57 lb O₂/hp-hr

Numerous characteristics and advantages of my invention have been set forth in the foregoing description, together with details of the structure and function of the invention, and the novel features thereof are pointed out in the appended claims. The disclosure, however, is illustrative only, and changes may be made in detail, especially in matters of shape, size, and arrangement of parts, within the principle of the invention, to the full extent indicated by the broad general meaning of the terms in which the appended claims are expressed.

1. An aerator apparatus for mixing a gas with a liquid having a surface comprising:
(a) a first motor having a shaft;
(b) a blower operatively connected to said first motor;
(c) a mixing chamber comprising an enclosing wall, said mixing chamber having a proximal opening and a distal opening;
(d) a bubble generator located within the mixing chamber, said bubble generator being operatively connected to said blower; and
(e) a second motor having a shaft operatively connected to a propeller;
wherein said propeller is positioned to propel water into said proximal opening of said mixing chamber and out of said distal opening of said mixing chamber.

2. The aerator apparatus of claim 1 further comprising a diffuser adjacent to said distal opening of said mixing chamber.

3. The aerator apparatus of claim 1 further comprising a plurality of means to facilitate mixing of said gas and liquid.

4. The aerator apparatus of claim 3 wherein said means to facilitate mixing of said gas and liquid are a plurality of vanes positioned within said mixing chamber.

5. The aerator apparatus of claim 3 wherein said means to facilitate mixing of said gas and liquid are a plurality of louvered openings positioned in said enclosing wall of said mixing chamber.

6. The aerator apparatus of claim 1 wherein said mixing chamber includes a plurality of openings in said enclosing wall of said mixing chamber.

7. The aerator apparatus of claim 1 wherein said bubble generator comprises: at least one manifold perpendicularly attached to a main tube running the length of the bubble generator and a plurality of porous tubes.

8. The aerator apparatus of claim 1 wherein said blower is operatively connected at said proximal opening of said mixing chamber.

9. The aerator apparatus of claim 1 wherein said aerator apparatus is mounted in a floatable frame.

10. The aerator apparatus of claim 7 wherein said at least one manifold includes a proximal manifold and an intermediate manifold having a first section of porous tubes connected there between and an intermediate manifold and a distal manifold having a second section of tubes connected therebetween.

11. The aerator apparatus of claim 9 wherein said mixing chamber is substantially parallel to the surface of a liquid.

12. The aerator apparatus of claim 9 wherein said bubble generator is substantially parallel to the surface of a liquid.

13. The aerator apparatus of claim 7 wherein said main pipe is porous to a gas.

14. A method of diffusing a gas into a liquid to be treated comprising the steps of:
(a) mounting the aeration apparatus of claim 1 on a floatable frame to form an aeration assembly;
(b) disposing said aeration assembly in said liquid to be treated;
(c) blowing a gas into said bubble generator;
(d) rotating the propeller to induce the flow of a liquid by said propeller through said mixing chamber;
(e) diffusing a gas into said liquid; and
(f) propelling said liquid from said aeration apparatus.

15. The method of claim 14 wherein said liquid to be treated is water in a pond.

16. The method of claim 14 wherein said liquid to be treated is water in a column.

17. The method of claim 14 wherein said gas is ambient air.

18. The method of claim 17 wherein the standard oxygen transfer rate is (K_{L}a₂₀)(9.07)(V)(0.001)(2.205).

19. A system for efficiently aerating a pond or column of water comprising:
the aerator apparatus of claim 1 wherein said bubble generator is enclosed in a removable housing and said removable housing is removably attached to said mixing chamber.

20. The system of claim 19 wherein said removable housing includes a plurality of vanes projecting from said removable housing.
